(19) United States
(12) Patent Application Publication
(10) Pub. No.: US 2018/0007428 A1
(43) Pub. Date: Jan. 4, 2018

(54) WIRELESS DISPLAY IMPLEMENTATION OF APPLICATIONS

(71) Applicant: Intel Corporation, Santa Clara, CA (US)

(72) Inventors: Karthik Veeramani, Hillsboro, OR (US); Rajneesh Chowdhury, Portland, OR (US)

(73) Assignee: Intel Corporation, Santa Clara, CA (US)

(21) Appl. No.: 15/196,220

(22) Filed: Jun. 29, 2016

(51) Int. Cl. H04N 21/4363; H04W 76/02; H04N 21/45; H04N 21/443; H04N 21/6437; H04L 29/06; H04W 84/12

(52) U.S. Cl. CPC H04N 21/43637; H04N 21/6437; H04W 76/023; H04L 65/608; H04N 21/4516; H04N 21/4431; H04W 84/12

(57) ABSTRACT

A system and method of wireless display, providing for a transmitter registering an application, and the application enabled via the transmitter transfer stack of the wireless display connection. The application operated between the transmitter and the receiver via the wireless display connection.

### TECHNICAL FIELD

The present techniques relate generally to wireless display, and more particularly, to implementation of applications via the wireless display connection between a transmitter and a receiver.

### BACKGROUND ART

A peer-to-peer wireless connection or direct wireless connection, such as with Wi-Fi Direct®, provides for wireless coupling of devices without a wireless access point (AP) router. Further, wireless display technology, such as Miracast™, may employ Wi-Fi Direct® to stream video and audio content wirelessly from a computing device such as a laptop, smartphone, or tablet, to a second device such as a monitor, television, or other computing device. In some cases, adapters may be employed on the receiver. For instance, adapters are available that plug into high definition multimedia interface (HDMI) ports or universal serial bus (USB) ports that enable non-Miracast devices to connect via Miracast™.

Miracast™ is a certification program of the Wi-Fi Alliance. Devices that are Miracast™ certified have a software implementation based on the Wi-Fi Display technical specification. The Wi-Fi Alliance maintains a current list of Miracast-certified devices. Both the sender and the receiver devices generally need to be Miracast™ certified for the technology to function. However, as mentioned, to stream music and movies to a non-certified device, Miracast™ adapters are available that plug into HDMI or USB ports. The technology generally works across devices, regardless of brand. Miracast™ devices negotiate settings for each connection, which may simplify the process for the users. In the competitive business of consumer electronics and services, there exists an ongoing need for continuous improvement in ease of development and implementation, user-experience, reliability, affordability, and so forth.

### BRIEF DESCRIPTION OF DRAWINGS

FIG. 1 is a block diagram of a system for wireless display in accordance with embodiments of the present techniques.

FIG. 2 is a block diagram of a system for wireless display in accordance with embodiments of the present techniques.

FIG. 3 is a block flow diagram of method for wireless display in accordance with embodiments of the present techniques.

FIG. 4 is a block diagram depicting an example of a tangible non-transitory, computer-readable medium that directs wireless display in accordance with embodiments of the present techniques.

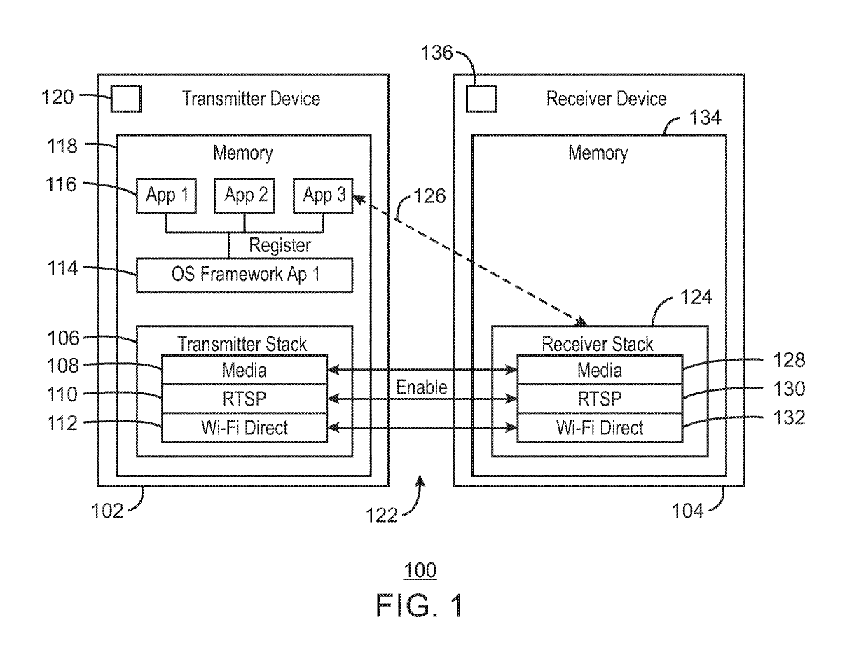

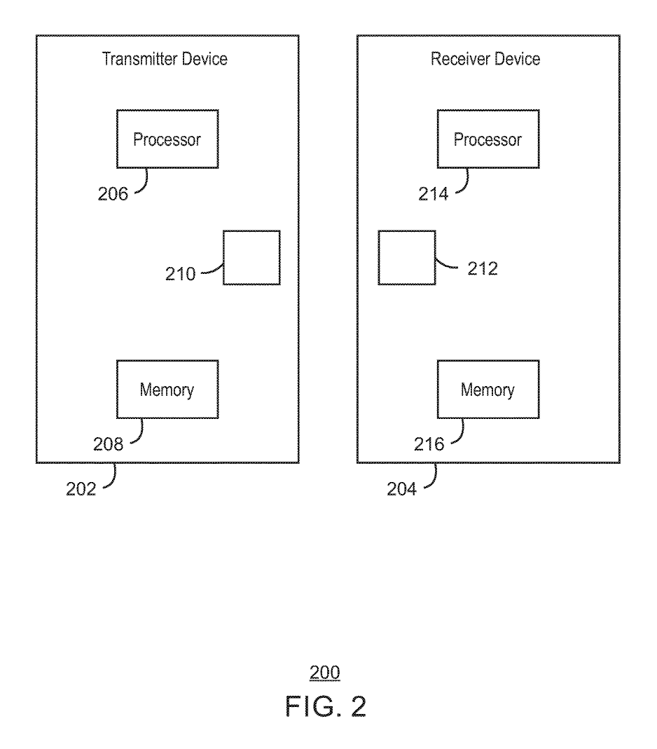

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

The present techniques relate generally to wireless display. Embodiments accommodate wirelessly streaming audio/video from a transmitter (e.g., a computing device) to a receiver over a wireless connection (e.g., wireless direct, peer-to-peer, Wi-Fi Direct®, etc.) and a wireless display connection (e.g., a Miracast™ connection, Apple AirPlay® connection, Google Chromecast™ connection, etc.). The techniques relate more particularly to application operation via the wireless display connection between the transmitter and the receiver. Certain embodiments provide a pluggable application-layer to extend wireless display services via Wi-Fi Direct® (e.g., including Miracast™, etc.). Some examples are applicable to various standards, such as the Miracast™ standard including revision two (R2) expected in 2017 and later revisions. However, other examples are not limited to a particular standard. Further, while the discussion herein may focus on Miracast™, the present techniques are applicable to other standards and wireless display services. For instance, some embodiments are applicable to Apple AirPlay®, Google Chromecast™, and other wireless display standards and connections. Indeed, the techniques may be applicable to wireless display service connections generally in which video, audio, data, etc. are transmitted wirelessly from a transmitter to a receiver. Moreover, while Wi-Fi Direct® generally does not require an access point (AP) router, some examples of the techniques may accommodate Wi-Fi via an AP router.

Wireless display solutions such as Miracast™ are becoming prevalent as smaller form-factor devices (e.g., smartphones, tablets, etc.) with significant computing have increased. Two popular operating systems—Windows and Android have implemented Miracast™ transmitter as an operating system (OS) feature. Moreover, as many as 3500 models of Miracast™ receiver are certified.

OS vendors, such as Microsoft and Google, ingrained Miracast™ transmitter stack into the OS without hooks for application developers to enhance the feature set. Such may be partially due to security concerns (e.g., with screen sharing) and partially due to low-level access for some features (e.g., Wi-Fi Direct®, graphics drivers, etc.), and so on. Yet, not all services that can benefit from a Miracast™ connection, such as a proprietary data sharing application, need access to low-level drivers. Further, Miracast™ receivers are generally updated more frequently than the Miracast™ transmitters. Indeed, in certain examples, receivers may typically be dedicated, firmware-based devices such as dongles or adapters plugged into a television, and other devices. This relatively frequent updating of receivers may facilitate receiver manufacturers to add functionality more quickly and/or frequently. However, the lack of a matching transmitter with such ease of adding functionality may bottleneck innovation.

Technology companies may desire to differentiate their transmitter-receiver stacks of wireless display service (e.g., Miracast™, etc.) through implementation of proprietary services, as well as through non-mandatory features of the wireless display standard (e.g., Miracast™ standard, etc.). Some companies have both transmitter and receiver stacks. For instance, Samsung smartphones may be a transmitter, and Samsung adapters (e.g., AllShareCast adapters) may be a receiver. In another example, LG smartphones may be a Miracast™ transmitter, and LG televisions may be a Miracast™ receiver, and so forth. Such companies may desire to implement extra features for differentiation.

In embodiments of the present techniques, new services or features may be uniquely added on top of Miracast™ (or on top of other wireless display services generally) without implementing an OS modification for each service or feature. Indeed, the Miracast™ specification and OS code may be enhanced on a one-time basis (or a few times) with changes (e.g., relatively simple changes) to facilitate on-going adding of new services or features with application level changes (e.g., with only application level changes) which are generally independent of the OS.

Therefore, embodiments may facilitate entities (e.g., independent software vendors or ISVs, other entities developing application layer code, and so forth) to add Miracast™ enhancements to the transmitter device that can work with a matching receiver, generally without requiring special privileges or engagements with OS manufacturers. An implementation of this technique may reduce development cost and speed innovation. With certain embodiments herein, entities can now generally move faster on innovating around wireless display without having to depend on, for example, Microsoft or Google for frequent OS changes.

In embodiments, the OS exposes an interface to high-level applications so that the OS can accept application add-on services on top of wireless display service (e.g., Miracast™, etc.), along with parameters such as port number where the OS and applications listen. In certain examples, this may be disabled by the user. While setting up the Miracast™ connection, the OS may check if a registered application is in the foreground, and if so, the OS may pass a feature advertised by the application to the peer (receiver), allowing the peer to directly negotiate and use the extra feature with the foreground application on the transmitter out-of-band, for example.

In contrast, a conventional approach is to modify (or have the OS vendor modify) OS code to negotiate a ‘vendor extension’ parameter in real time streaming protocol (RTSP) M3 phase of the Miracast™ connection. If the receiver is manufactured by the same original equipment manufacturer (OEM) or their partner, the feature gets enabled. Such a conventional example is Intel® WiDi software running on Windows ultrabooks with Actiontec and other WiDi certified receivers. Another such conventional examples include Samsung, LG, and Sony smartphones and tablets running Android with the receivers as TVs and receiver dongles manufactured by them. The drawback with this approach may be one typically has to modify the OS each time a new feature needs to be added, in order to negotiate the parameters for that feature. This is often not possible for a small company that works only on application layer software. Even for companies that can influence OS vendor to change their code, the software development cycle can become significantly longer.

Conversely, embodiments of the present techniques may provide a more generic technique that involves a one-time change (or two to three changes) in the OS and wireless display specification. Also, the OS and/or wireless display specification may be initially drafted with the changes or features. To illustrate, two example use cases such as the following can be enabled. The first example is an image editing software running on a laptop (Miracast™ transmitter) wants to use a head mounted device as a second display (Miracast™ receiver) to preview a rendered panoramic image. The image editing software can receive gyroscope inputs from the head mounted device and render another part of the image that the user is focusing on. With embodiments herein, the image editor can register a service with the OS, to which the receiver stack on the head mounted display could send gyroscope inputs, as long as the image editor is running in the foreground. When the image editor is closed, the OS notifies the head mounted device, and the software stops sending gyroscope inputs.

The second example is a Miracast™ receiver accepts connection from multiple transmitter devices and lets the user interact between them. The receiver vendor provides an app for most or all transmitter platforms, that lets a user transfer files from one transmitter to another through the Miracast™ connection to receiver. This can be facilitated by implementing embodiments discussed herein, as the transmitter applications can register an add-on with the transmitter Miracast™ stack, allowing the user to transfer content between the transmitter devices through the receiver using an out-of-band channel.

FIG. 1 is a system 100 accommodating wireless display. The system includes a transmitter device 102 and a receiver device 104. The transmitter device 102 may be a computing device, laptop, desktop, smartphone, tablet, and so on. The receiver device 104 may be a computing device, laptop, monitor, wireless monitor, television, dongle, mini-personal computer, next unit of computing or NUC, tablet, smartphone, and so forth. As discussed below, the system architecture of system 100 may benefit manufacturers of software and/or hardware for wireless display transmitters and receivers. Investment in no-wires products may be bolstered by this platform differentiating features.

At the outset, at least two basic factors may be considered. First, embodiments may facilitate a channel to connect add-on services of two devices over Miracast™. The type of services and the associated protocols, and the like, may be prior knowledge to the receiver and to the transmitter application. For instance, the same vendor manufacturing a receiver device could supply an application on a smartphone (as transmitter) platform's app store, enabling additional features when the user is interacting with their app (e.g., only when the user is interacting with their app). In this case, both parties may know about the protocol details of the service they want to enable. Second, the service offered by the application may be well-known or proprietary, each service identified through a unique identifier such as a universally unique identifier or uuid. For example, an application or app may implement a user input back channel (UIBC), which is an optional feature of Miracast™, when the app is running. The application may identify the service through a uuid known to the receiver, or a uuid of a proprietary feature whose protocol is not published, and the like.

In particular examples, the operational flow may be as follows. Initially, when an application is installed on the transmitter, the application uses an OS provided mechanism to register a service the application can offer. The parameters of the service include (but not limited to) a unique identifier (uuid) for the service, a network port number on which the application would be available, and a description of the service. The registration could be performed either at runtime through an application program interface (API) call during the first run of the application, or through a static manifest file, such as an initialization or INI file, or AndroidManifest.xml, that the OS would look into before installing the application. The OS may maintain a registry of the service parameters for each registered application. The user is generally given an option to allow or disallow the service advertised by the application. If the user does not allow the application or service, then operational flow ends.

On the other hand, if the user allows the application or service, the operation flow continues. Thus, continuing when a wireless display (e.g., Miracast™) connection is established, an internet protocol (IP) address may be made available to the transmitter and receiver devices per the wireless display (e.g., Miracast™) specification. This may be facilitated by the Wi-Fi Direct® module. The devices may then negotiate their capabilities in the RTSP phase of the connection and maintain the RTSP connection open for later use. The following three actions (1), (2), and (3) may be implemented.

(1) After the RTSP connection, when the user launches one of the registered applications on the transmitter, in a specific example, the following RTSP SET PARAMETER may be sent from transmitter to the receiver: wfd-addon-service=“wfd_addon_service:” SP uuid SP “enable”/“disable” SP IPPORT SP description, uuid=Unique identifier of a service. description=Friendly description of the service. PPORT=Port on which service is available on the network interface established by Miracast™. The “enable” field may set to enable the service (when the app is in the foreground) and “disable” may set to turn off the application when the application is no longer in the foreground. The port number may be made available by the OS on the network interface created by Miracast™ during the Wi-Fi Direct® exchanges. If the app is already in the foreground when the Miracast™ connection is being setup, the parameter may be sent as part of RTSP M4 request to enable the service after the connection.

(2) If the receiver recognizes the service and that the application providing the service is in the foreground (if “enable” was set in the parameter), the receiver may make a direct connection to the service on the advertised port on the Miracast™ interface and start following the associated protocol to use the feature.

(3) If the user closes the foreground application on the transmitter, the OS may send the RTSP parameter again with “disabled” field set. The remaining parameters following “disabled” may be ignored. Upon receiving this, the receiver stops communicating on the port number advertised earlier for the service. Lastly, when the user launches another registered application to the foreground, actions (1), (2), and (3) above may be repeated.

Through the above technique, network applications may leverage an ad-hoc connection provided by Miracast™ and provide additional features on top of the Miracast™ standard. The one-time changes in the operating system of the transmitter and the Miracast™ spec may allow for a shorter development cycle to add new features, and speed innovation in this domain.

In the illustrated embodiment of FIG. 1, the transmitter device 102 includes a software transfer stack 106 (e.g., Miracast™ transfer stack or other wireless display transfer stack) including media (and other services) 108, RTSP 110, and Wi-Fi Direct® 112. The transmitter device 102 includes an OS 114 which is modified (e.g., via an update) to include a framework API for registering applications, as discussed above. In the depicted embodiment, the transmitter device 102 has three applications 116 to interact with the receiver device 104 on top of a Miracast™ connection. An example of an application 116 is a file-sharing application. Of course, other examples of applications are applicable. Moreover, in certain examples, the applications 116 after registration may operate and/or communicate with the receiver device 104 independent of the OS 114. Further, the number of applications 116 can be less than three or more than three.

Furthermore, the aforementioned components including the applications 116 and the Miracast™ transfer stack 106 may be code (instructions, logic) stored in memory 118 and executed by the processor 120. The memory 118 may include non-volatile memory, volatile memory, firmware, cache, and so on. The processor 120 may be more than one processor and each processor may have more than one core. The processor 120 is generally a hardware processor such as a microprocessor, central processing unit (CPU), or other processor.

The receiver device 104 includes a software transfer stack 124 (e.g., Miracast™ transfer stack or other wireless display transfer stack) including media (and other services) 128, RTSP 130, and Wi-Fi Direct® 132. These components may be code (instructions, logic) stored in memory 134 and executed by the processor 136. The memory 134 may include non-volatile memory, volatile memory, firmware, cache, and the like. The processor 136 may be more than one processor and each processor may have more than one core. The processor 136 is generally a hardware processor such as a microprocessor, CPU, or other processor.

The transmitter device 102 and receiver device 104 may establish a wireless display service (e.g., Miracast™) connection, for example, via Wi-Fi Direct®, as indicated by arrows 122. The devices 102 and 104 may each have a wireless network adapter or other wireless interface for the wireless connection. In operation, the one or more applications 116 may register with the OS 114 of the transmitter device. The OS 114 may have been previously modified to include (or originally included) a framework API to register the applications 116. Thus, the OS 114 may accommodate a register service for the applications 116. The registration can be performed at runtime through an API call, as discussed. Moreover, in certain embodiments, a parameter can be sent to the receiver 106 initially or later, such by the OS 114. Further, an application 116 in the foreground may be enabled, for example, via the RTSP 108 to RTSP 130. In other words, the RTSP 108 may advertise the extra parameter associated with the application 116 and verify the application 116 is in the foreground. In some embodiments, the application 116 must be in the foreground to be enabled. Generic parameters may include a unique ID, the port number, description, and so on. Again, both the OS 114 and wireless display service (e.g., Miracast™) specification may be modified with a generic change to include (or originally include) executable code to accommodate registration (by the OS 114) enabling (via Miracast™) of the applications 116, and operation for both sides (transmitter 102 and receiver 106) to implement the applications. In operation, the features may be between the application 116 and the receiver 104, as represented by arrow 126.

As indicated, the OS 114 may perform registration of the application 116 at runtime through an API call during the first run of the application, or through other techniques such as an INI file the OS 114 would evaluate before installing the application 116. Again, the API call may include a unique ID, port number, parameter, and so forth. The OS 114 may maintain a registry of the service parameters for each registered application 116. The application 116 may function on top of the Miracast™ connection. As also mentioned, the user is generally given an option to allow or disallow the service advertised by the application 116.

Moreover, in certain embodiments, the transmitter device 102 notifies the receiver device 104 when one of the registered applications 116 comes to foreground or goes to the background, so that the receiver device 102 can switch communication between the applications 116. Indeed, when a registered application 116 goes to the background, the receiver device 104 can stop communication with that application 116. When a registered application 116 goes to the foreground, the receiver device 104 can start communication with that application 116. Therefore, with the transmitter device 102 notifying the receiver device 104 if a first registered application 116 in the foreground goes to the background, and a second registered application 116 comes to the foreground, the receiver device 104 can stop communication with the first registered application 116 and start communication with the second registered application 116.

FIG. 2 is a system 200 providing for wireless display. The system 200 may be similar or identical to the system 100 of FIG. 1. Embodiments accommodate wirelessly streaming audio/video from a transmitter 202 (e.g., a computing device) to a receiver 204 over a wireless connection (e.g., Wi-Fi Direct®) and a wireless display connection (e.g., a Miracast™ connection). In particular examples, the transmitter 202 is a laptop, smartphone, or tablet, and the receiver 204 is a monitor or TV. As with FIG. 1, the transmitter 202 has a processor 206 and memory 208 storing code (instructions, logic) executable by the processor 206. The code may be the aforementioned code discussed as stored in memory 118 of FIG. 1.

In the illustrated embodiment, the transmitter 102 includes a network interface 210 (e.g., network adapter) for a wireless connection. Similarly, the receiver 204 includes a network interface 212 (e.g., network adapter) for a wireless connection. Further, the receiver 204 has a processor 214 and memory 216 storing code executable by the processor 214. The code may be the aforementioned code discussed as stored in memory 134 of FIG. 2. As indicated, a wireless display (e.g., Miracast™) connection may be established between the transmitter 202 (e.g., computing device) and the receiver 204.

The system 200 may provide for an application stored in memory 208 of the transmitter 202 to run on top of the Miracast™ connection. In embodiments, the application must or should be in the foreground to run on top of the Miracast™ connection. In certain embodiments, the memory 108 stores code executable by the processor 106 to register the application via an operating system (e.g., via a framework API) of the transmitter 202, and enable the application via the transfer stack (e.g., via the RTSP stored in the memory 208 of the transmitter 202) for the wireless display service connection. When enabled, the application may operate between the transmitter 202 and the receiver 204 via the wireless display service connection (e.g., via the RTSP). The application may be stored in the memory 208 of the transmitter 202. In one example, the application is a file-sharing application. In another example, the application is an image editor. Other applications are applicable.

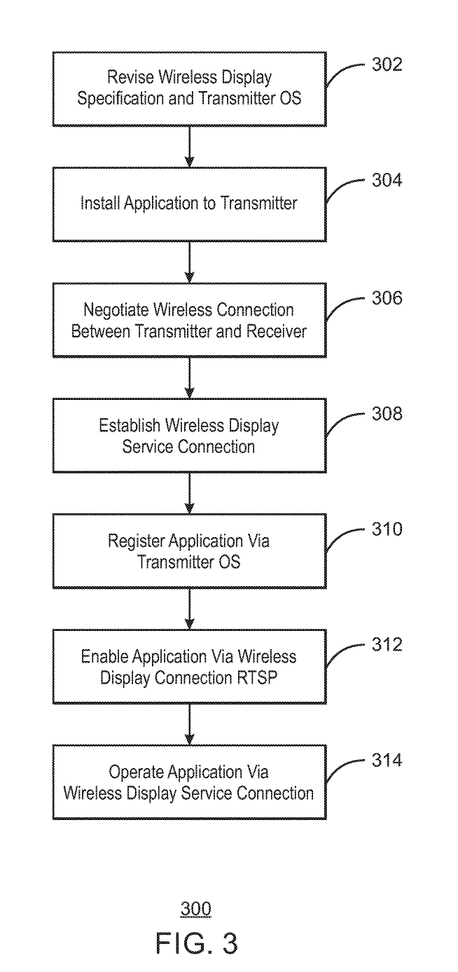

FIG. 3 is a method 300 for wireless display between a transmitter and receiver, the transmitter storing applications. At block 302, various standards or executable code may be revised or updated. For example, the wireless display standard or specification may be revised to provide for enabling of applications via the wireless display (e.g., Miracast™) transfer stack of the transmitter. Also, the transmitter OS may be revised or updated to provide for registering of the applications, such as via an API framework. At block 304, an application (e.g., a file-sharing application, image editor, video editor, etc.) is installed on the transmitter.

At block 306, the method includes negotiating a wireless connection between the transmitter and the receiver. Indeed, the transmitter establishes a direct wireless connection (e.g., peer-to-peer, Wi-Fi Direct®, etc.) with the receiver. At block 308, the method includes establishing a wireless display connection from the transmitter to receiver over the wireless connection. The transmitter establishes a wireless display services connection (e.g., a Miracast™ connection) with the receiver. The operation may include wirelessly streaming video or audio, or both, from the transmitter to the receiver over the wireless connection and the wireless display connection.

In operation with respect to the application, the method includes the transmitter OS registering (block 310) the application, e.g., so that the application can operate on top of the Miracast™ connection. If an API framework of the transmitter OS is employed to register the application, the API call may include a unique ID, port number, parameter, and so forth. The transmitter OS may maintain a registry of the service parameters for each registered application. As also mentioned, the user is generally given an option to allow or disallow the service advertised by the application. Further, in certain examples, after registration, the application is then enabled (block 312) via the wireless display connection RTSP. At block 314, the application is operated via or on top of the wireless display service connection, and wherein the application operation may be generally independent of the transmitter OS. In some examples, the transmitter may be a laptop, smartphone, or tablet, or other computing device.

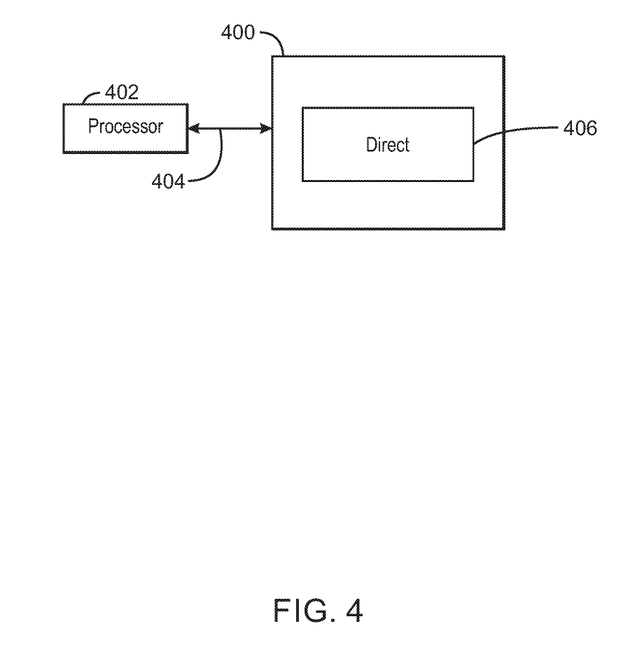

FIG. 4 is a block diagram depicting an example of a tangible non-transitory, computer-readable medium 400 that can facilitate application registration and enablement in a wireless display environment, as discussed above. The computer-readable medium 400 may be accessed by a processor 402 over a computer interconnect 404. The processor 402 may be a processor (e.g., 120) of the computing device. The tangible, non-transitory, computer-readable medium 400 may include executable instructions or code to direct the processor 402 to perform the operations of the techniques described herein.

The various software components discussed herein may be stored on the tangible, non-transitory, computer-readable medium 400, as indicated in FIG. 4. For example, with respect to an application running on a transmitter device (computing device) in wireless display connection with a receiver device, a direct module 406 (executable code/instructions) may direct the processor 402 to register the application via an operating system of the transmitter, enable the application via a transfer stack (e.g., the RTSP) of the wireless display connection, and operate the application between the transmitter and the receiver via the wireless display connection. It should be understood that any number of additional software components not shown in FIG. 4 may be included within the tangible, non-transitory, computer-readable medium 400, depending on the application or other considerations. Moreover, while one module 406 is depicted, additional modules directed to other code and actions may be stored on medium 400.

Lastly, the applications (including the applications 116 in FIG. 1) that may be employed with the present techniques include a variety of applications. As discussed, the applications may be registered, for example, via the transmitter OS and enabled via the transmitter transfer stack (e.g., RTSP) for the wireless display, and then the applications operate generally independent of the transmitter OS. One example of such applications mentioned is file-sharing applications. Other examples mentioned include image editing software and which may use a head mounted device, for instance. Indeed, the image editor can register a service with the OS, to which the receiver stack on the head mounted display could send gyroscope inputs, with the image editor running in the foreground. Additional examples mentioned include in an environment with the wireless display receiver accepting connections from multiple transmitter devices and the application facilitating the user to interact between the transmitter devices. For instance, the receiver vendor may provide an application for most or all transmitter platforms and that provides for a user to transfer files from one transmitter to another through the wireless display connection via the receiver. In particular, the transmitter applications can register an add-on with the transmitter wireless display stack, providing for the user to transfer content between the transmitter devices through the receiver using an out-of-band channel, for example. Of course, many other applications are applicable to the present techniques.

Particular examples of applications include with respect to employment of a gyroscope and many types of sensors. For instance, consider that a game application, image editor application, video editor application, etc. is running on the transmitter. The application may support various sensor inputs to update its content. For instance, a gyroscope input may make the application move some characters in the game, or scroll to a different part of an image preview, and so forth. For example, the receiver can be a head-mounted device that has sensors built-in (e.g., eye tracking, gyroscope, accelerometer, etc.). When a user mirrors the transmitter to the head-mounted display and the user moves their head, these sensor inputs can be fed back to the transmitter, causing the application to utilize the inputs for better experience. However, Miracast™ R1 specification does not support these input types. The Miracast™ R2 draft specification accommodates gyroscope and accelerometer but not eye tracking. Therefore, instead of relying on a Miracast™ specification (or other wireless display specification) to update for newer input types, some embodiments herein may be utilized.

For example, as discussed, the application may be registered with the transmitter OS, and the head-mounted display (HMD) aware of the application's presences in the foreground. In specific examples, the HMD can communicate straight with the application and feed inputs back in a proprietary format understood by the application. The HMD can stop feeding inputs to the application when the application goes away, or the HMD switch to feeding a different type of input to the next application that comes forward. For instance, say the first application is an image editor supporting gyroscope input, and the second application is a game that updates game content based on eye position. However, again, embodiments herein may cover a broader set of applications, including various sensor usages, and the like.

As can be appreciated, an HMD may be pair of goggles, a full helmet, and so on. In general, an HMD may be a display device worn on the head or as part of a helmet, and that has a small display optic in front of one eye (monocular HMD) or each eye (binocular HMD). An HMD may provide for display of a computer-generated image, sometimes referred to as a virtual image. Some HMDs provide for a CGI (computer generated imagery) to be superimposed on the view. Using principles of angular momentum, the gyroscope indicates orientation. In comparison, the accelerometer measures acceleration. Such devices may be employed in aircraft and automobiles, as well as smartphones and other electronic devices.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

In addition to being used in compasses, aircraft, computer pointing devices, etc., gyroscopes have been introduced into consumer electronics. Since the gyroscope allows the calculation of orientation and rotation, designers have incorporated them into modern technology. The integration of the gyroscope has allowed for more accurate recognition of movement within a 3D space than the previous lone accelerometer within a number of smartphones. Gyroscopes in consumer electronics are frequently combined with accelerometers (acceleration sensors) for more robust direction- and motion-sensing.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Examples are given. Example 1 is a method of wireless display. The method includes negotiating a wireless connection between a transmitter and a receiver to wirelessly couple the transmitter and the receiver; establishing a wireless display connection between the transmitter and the receiver; registering an application via an operating system of the transmitter, the application stored on the transmitter; enabling the application via a transmitter transfer stack of the wireless display connection; and operating the application between the transmitter and the receiver via the wireless display connection.

Example 2 includes the method of example 1, including or excluding optional features. In this example, enabling the application via the transmitter transfer stack comprises enabling the wireless connection via a real time streaming protocol (RTSP) of the wireless display connection.

Example 3 includes the method of any one of examples 1 to 2, including or excluding optional features. In this example, the method includes updating the operating system of the transmitter to include a framework application program interface (API) for registering the application.

Example 4 includes the method of any one of examples 1 to 3, including or excluding optional features. In this example, the method includes updating a services specification of the wireless display connection for the transmitter transfer stack to enable the application.

Example 5 includes the method of any one of examples 1 to 4, including or excluding optional features. In this example, the wireless connection comprises a Wi-Fi Direct® connection.

Example 6 includes the method of any one of examples 1 to 5, including or excluding optional features. In this example, the wireless display connection comprises a Miracast™ connection.

Example 7 includes the method of any one of examples 1 to 6, including or excluding optional features. In this example, the method includes wirelessly streaming video or audio, or both, from the transmitter to the receiver over the wireless connection and the wireless display connection, wherein the transmitter comprises a computing device.

Example 8 includes the method of any one of examples 1 to 7, including or excluding optional features. In this example, the method includes installing the application on the transmitter, wherein enabling the application via the transmitter transfer stack comprises enabling the application without reliance on the operating system.

Example 9 is a transmitter configured for wireless display. The transmitter configured for wireless display includes a processor; and memory storing instructions executable by the processor to: negotiate a wireless connection between the transmitter and a receiver to wirelessly couple the transmitter and the receiver, wherein the transmitter comprises a computing device; establish a wireless display service connection between the transmitter and the receiver; register an application via an operating system of the transmitter, the application stored in the memory of the transmitter; enable the application via the instructions comprising a transfer stack for the wireless display service connection; and operate the application between the transmitter and the receiver via the wireless display service connection.

Example 10 includes the transmitter configured for wireless display of example 9, including or excluding optional features. In this example, to enable the application via the transfer stack comprises enabling the wireless connection via a real time streaming protocol (RTSP) of the transfer stack for the wireless display connection.

Example 11 includes the transmitter configured for wireless display of any one of examples 9 to 10, including or excluding optional features. In this example, the operating system of the transmitter comprises a framework application program interface (API) for registering the application.

Example 12 includes the transmitter configured for wireless display of any one of examples 9 to 11, including or excluding optional features. In this example, the wireless connection comprises a Wi-Fi Direct® connection.

Example 13 includes the transmitter configured for wireless display of any one of examples 9 to 12, including or excluding optional features. In this example, the wireless display service connection comprises a Miracast™ connection.

Example 14 includes the transmitter configured for wireless display of any one of examples 9 to 13, including or excluding optional features. In this example, to enable the application via the transmitter transfer stack comprises to enable the application without reliance on the operating system.

Example 15 includes the transmitter configured for wireless display of any one of examples 9 to 14, including or excluding optional features. In this example, the instructions comprise an update to the operating system for the operating system to register applications.

Example 16 includes the transmitter configured for wireless display of any one of examples 9 to 15, including or excluding optional features. In this example, the instructions are executable by the processor to wirelessly stream video or audio, or both, from the transmitter to the receiver over the wireless connection and the wireless display service connection.

Example 17 is a tangible, non-transitory, computer-readable medium. The computer-readable medium includes instructions that direct the processor to negotiate a wireless connection between a transmitter and a receiver to wirelessly couple the transmitter and the receiver, wherein the transmitter comprises the computing device; establish a wireless display service connection between the transmitter and the receiver; register an application via an operating system of the transmitter, the application stored in memory of the transmitter; and enable the application via the instructions comprising a transfer stack for the wireless display service connection.

Example 18 includes the computer-readable medium of example 17, including or excluding optional features. In this example, the instructions are executable by a processor operate the application between the transmitter and the receiver via the wireless display service connection.

Example 19 includes the computer-readable medium of any one of examples 17 to 18, including or excluding optional features. In this example, to enable the application via the transfer stack comprises enabling the wireless connection via a real time streaming protocol (RTSP) of the wireless display connection.

Example 20 includes the computer-readable medium of any one of examples 17 to 19, including or excluding optional features. In this example, the operating system of the transmitter comprises a framework application program interface (API) for registering the application.

Example 21 includes the computer-readable medium of any one of examples 17 to 20, including or excluding optional features. In this example, the wireless connection comprises a Wi-Fi Direct® connection.

Example 22 includes the computer-readable medium of any one of examples 17 to 21, including or excluding optional features. In this example, the wireless display service connection comprises a Miracast™ connection.

Example 23 includes the computer-readable medium of any one of examples 17 to 22, including or excluding optional features. In this example, to enable the application via the transmitter transfer stack comprises to enable the application without reliance on the operating system.

Example 24 includes the computer-readable medium of any one of examples 17 to 23, including or excluding optional features. In this example, the instructions comprise an update to the operating system for the operating system to register the application.

Example 25 includes the computer-readable medium of any one of examples 17 to 24, including or excluding optional features. In this example, the transmitter to wirelessly stream video or audio, or both, from the transmitter to the receiver over the wireless connection and the wireless display service connection.

Example 26 includes the computer-readable medium of any one of examples 17 to 25, including or excluding optional features. In this example, the transmitter comprises a laptop.

Example 27 includes the computer-readable medium of any one of examples 17 to 26, including or excluding optional features. In this example, the transmitter comprises a smartphone.

Example 28 includes the computer-readable medium of any one of examples 17 to 27, including or excluding optional features. In this example, the transmitter comprises a tablet.

Example 29 includes the computer-readable medium of any one of examples 17 to 28, including or excluding optional features. In this example, the transmitter comprises a desktop computer.

Example 30 includes the computer-readable medium of any one of examples 17 to 29, including or excluding optional features. In this example, the application comprises a file-sharing application.

Example 31 includes the computer-readable medium of any one of examples 17 to 30, including or excluding optional features. In this example, the application facilitates the receiver to accept wireless display connections from multiple transmitters, and the application facilitates a user to interact between the transmitter devices via the receiver.

Example 32 includes the computer-readable medium of any one of examples 17 to 31, including or excluding optional features. In this example, the application comprises a game.

Example 33 includes the computer-readable medium of any one of examples 17 to 32, including or excluding optional features. In this example, the application comprises an image editor.

Example 34 includes the computer-readable medium of any one of examples 17 to 33, including or excluding optional features. In this example, the application comprises a video editor.

Example 35 includes the computer-readable medium of any one of examples 17 to 34, including or excluding optional features. In this example, the application to interface with a head-mounted device.

Example 36 includes the computer-readable medium of any one of examples 17 to 35, including or excluding optional features. In this example, the application to accept sensor inputs.

Example 37 includes the computer-readable medium of any one of examples 17 to 36, including or excluding optional features. In this example, the application to accept gyroscope inputs.

Example 38 includes the computer-readable medium of any one of examples 17 to 37, including or excluding optional features. In this example, the application to accept eye tracking inputs.

Example 39 includes the computer-readable medium of any one of examples 17 to 38, including or excluding optional features. In this example, the application to accelerometer inputs.

Example 40 includes the computer-readable medium of any one of examples 17 to 39, including or excluding optional features. In this example, the receiver comprises a head-mounted device having sensors.

Example 41 includes the computer-readable medium of any one of examples 17 to 40, including or excluding optional features. In this example, the receiver comprises a head-mounted device having an eye-tracking sensor, or a gyroscope sensor, or an accelerometer sensor, or any combination thereof.

Example 42 is a method by a transmitter in wireless display. The method includes negotiating a wireless connection with a receiver to wirelessly couple the transmitter to the receiver, wherein the transmitter comprises a computing device; establishing a wireless display service connection with the receiver; registering an application via an operating system of the transmitter, the application stored in memory of the transmitter; and enabling the application via a transfer stack for the wireless display service connection.

Example 43 includes the method of example 42, including or excluding optional features. In this example, the method includes operating the application between the transmitter and the receiver via the wireless display service connection.

Example 44 includes the method of any one of examples 42 to 43, including or excluding optional features. In this example, enabling the application via the transfer stack comprises enabling the wireless connection via a real time streaming protocol (RTSP) of the wireless display connection.

Example 45 includes the method of any one of examples 42 to 44, including or excluding optional features. In this example, the operating system of the transmitter comprises a framework application program interface (API) for registering the application.

Example 46 includes the method of any one of examples 42 to 45, including or excluding optional features. In this example, the wireless connection comprises a Wi-Fi Direct® connection.

Example 47 includes the method of any one of examples 42 to 46, including or excluding optional features. In this example, the wireless display service connection comprises a Miracast™ connection.

Example 48 includes the method of any one of examples 42 to 47, including or excluding optional features. In this example, enabling the application via the transmitter transfer stack comprises enabling the application without reliance on the operating system.

Example 49 includes the method of any one of examples 42 to 48, including or excluding optional features. In this example, the method includes updating the operating system for the operating system to register the application.

Example 50 includes the method of any one of examples 42 to 49, including or excluding optional features. In this example, the method includes wirelessly streaming video or audio, or both, from the transmitter to the receiver over the wireless connection and the wireless display service connection.

Example 51 includes the method of any one of examples 42 to 50, including or excluding optional features. In this example, the transmitter comprises a laptop.

Example 52 includes the method of any one of examples 42 to 51, including or excluding optional features. In this example, the transmitter comprises a smartphone.

Example 53 includes the method of any one of examples 42 to 52, including or excluding optional features. In this example, the transmitter comprises a tablet.

Example 54 includes the method of any one of examples 42 to 53, including or excluding optional features. In this example, the transmitter comprises a desktop computer.

Example 55 includes the method of any one of examples 42 to 54, including or excluding optional features. In this example, the transmitter comprises a television.

Example 56 includes the method of any one of examples 42 to 55, including or excluding optional features. In this example, the application comprises a file-sharing application.

Example 57 includes the method of any one of examples 42 to 56, including or excluding optional features. In this example, the method includes interacting between the transmitter and other transmitters via the receiver and the application.

Example 58 includes the method of any one of examples 42 to 57, including or excluding optional features. In this example, the application comprises a game.

Example 59 includes the method of any one of examples 42 to 58, including or excluding optional features. In this example, the application comprises an image editor.

Example 60 includes the method of any one of examples 42 to 59, including or excluding optional features. In this example, the application comprises a video editor.

Example 61 includes the method of any one of examples 42 to 60, including or excluding optional features. In this example, the method includes the transmitter interfacing with a head-mounted device via the application.

Example 62 includes the method of any one of examples 42 to 61, including or excluding optional features. In this example, the method includes the application receiving inputs from a sensor.

Example 63 includes the method of any one of examples 42 to 62, including or excluding optional features. In this example, the method includes the application receiving inputs from a gyroscope sensor.

Example 64 includes the method of any one of examples 42 to 63, including or excluding optional features. In this example, the method includes the application receiving inputs from an eye tracking sensor.

Example 65 includes the method of any one of examples 42 to 64, including or excluding optional features. In this example, the method includes the application receiving inputs from an accelerometer.

Example 66 includes the method of any one of examples 42 to 65, including or excluding optional features. In this example, the receiver comprises a head-mounted device having a sensor.

Example 67 includes the method of any one of examples 42 to 66, including or excluding optional features. In this example, the receiver comprises a head-mounted device having an eye-tracking sensor, or a gyroscope sensor, or an accelerometer sensor, or any combination thereof.

Example 68 is a method of wireless display. The method includes negotiating a wireless connection between a transmitter and a receiver to wirelessly couple the transmitter and the receiver, wherein the transmitter comprises a computing device; establishing a wireless display connection between the transmitter and the receiver; registering an application via an operating system of the transmitter, the application stored on the transmitter; enabling the application via a transmitter transfer stack of the wireless display connection; and operating the application between the transmitter and the receiver via the wireless display connection.

Example 69 includes the method of example 68, including or excluding optional features. In this example, the operating system of the transmitter comprises a framework application program interface (API) for registering the application, and wherein enabling the application via the transmitter transfer stack comprises enabling the wireless connection via a real time streaming protocol (RTSP) of the wireless display connection.

Example 70 includes the method of any one of examples 68 to 69, including or excluding optional features. In this example, the wireless connection comprises a Wi-Fi Direct® connection, and wherein the wireless display connection comprises a Miracast™ connection.

Example 71 includes the method of any one of examples 68 to 70, including or excluding optional features. In this example, the method includes wirelessly streaming video or audio, or both, from the transmitter to the receiver over the wireless connection and the wireless display connection.

Example 72 includes the method of any one of examples 68 to 71, including or excluding optional features. In this example, the method includes installing the application on the transmitter.

Example 73 includes the method of any one of examples 68 to 72, including or excluding optional features. In this example, enabling the application via the transmitter transfer stack comprises enabling the application without reliance on the operating system.

Example 74 is a transmitter. The transmitter includes a processor. Further, the transmitter includes memory storing instructions executable by the processor to: negotiate a wireless connection between the transmitter and a receiver to wirelessly couple the transmitter and the receiver; establish a wireless display service connection between the transmitter and the receiver; register an application via an operating system of the transmitter, the application stored in the memory of the transmitter; enable the application via the instructions comprising a transfer stack for the wireless display service connection; and operate the application between the transmitter and the receiver via the wireless display service connection.

Example 75 includes the transmitter of example 74, including or excluding optional features. In this example, to enable the application via the transfer stack comprises enabling the wireless connection via a real time streaming protocol (RTSP) of the transfer stack for the wireless display connection, and wherein the operating system of the transmitter comprises a framework application program interface (API) for registering the application.

Example 76 includes the transmitter of any one of examples 74 to 75, including or excluding optional features. In this example, the wireless connection comprises a Wi-Fi Direct® connection, and wherein the wireless display service connection comprises a Miracast™ connection.

Example 77 includes the transmitter of any one of examples 74 to 76, including or excluding optional features. In this example, to enable the application via the transmitter transfer stack comprises to enable the application without reliance on the operating system.

Example 78 includes the transmitter of any one of examples 74 to 77, including or excluding optional features. In this example, the transmitter to wirelessly stream video or audio, or both, to the receiver over the wireless connection and the wireless display service connection.

Example 79 is a tangible, non-transitory, computer-readable medium. The computer-readable medium includes instructions that direct the processor to negotiate a wireless connection between a transmitter and a receiver to wirelessly couple the transmitter and the receiver, wherein the transmitter comprises the computing device; establish a wireless display service connection between the transmitter and the receiver; register an application via an operating system of the transmitter, the application stored in memory of the transmitter; enable the application via the instructions comprising a transfer stack for the wireless display service connection; and operate the application between the transmitter and the receiver via the wireless display service connection.

Example 80 includes the computer-readable medium of example 79, including or excluding optional features. In this example, to enable the application via the transfer stack comprises enabling the wireless connection via a real time streaming protocol (RTSP) of the wireless display connection, and wherein the operating system of the transmitter comprises a framework application program interface (API) for registering the application.

Example 81 includes the computer-readable medium of any one of examples 79 to 80, including or excluding optional features. In this example, the wireless connection comprises a Wi-Fi Direct® connection, and wherein the wireless display service connection comprises a Miracast™ connection.

Example 82 includes the computer-readable medium of any one of examples 79 to 81, including or excluding optional features. In this example, to enable the application via the transmitter transfer stack comprises to enable the application without reliance on the operating system.

Example 83 includes the computer-readable medium of any one of examples 79 to 82, including or excluding optional features. In this example, the instructions comprise an update to the operating system for the operating system to register the application.

Example 84 includes the computer-readable medium of any one of examples 79 to 83, including or excluding optional features. In this example, the wireless display service connection comprises an Apple AirPlay® connection.

Example 85 includes the computer-readable medium of any one of examples 79 to 84, including or excluding optional features. In this example, the wireless display service connection comprises a Google Chromecast™ connection.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. A method of wireless display, comprising:
negotiating a wireless connection between a transmitter and a receiver to wirelessly couple the transmitter and the receiver;
establishing a wireless display connection between the transmitter and the receiver;
registering an application via an operating system of the transmitter, the application stored on the transmitter;
enabling the application via a transmitter transfer stack of the wireless display connection; and
operating the application between the transmitter and the receiver via the wireless display connection.

2. The method of claim 1, wherein enabling the application via the transmitter transfer stack comprises enabling the wireless connection via a real time streaming protocol (RTSP) of the wireless display connection.

3. The method of claim 1, comprising updating the operating system of the transmitter to include a framework application program interface (API) for registering the application.

4. The method of claim 1, comprising updating a services specification of the wireless display connection for the transmitter transfer stack to enable the application.

5. The method of claim 1, wherein the wireless connection comprises a Wi-Fi Direct® connection.

6. The method of claim 1, wherein the wireless display connection comprises a Miracast™ connection.

7. The method of claim 1, comprising wirelessly streaming video or audio, or both, from the transmitter to the receiver over the wireless connection and the wireless display connection, wherein the transmitter comprises a computing device.

8. The method of claim 1, comprising installing the application on the transmitter, wherein enabling the application via the transmitter transfer stack comprises enabling the application without reliance on the operating system.

9. A transmitter configured for wireless display, comprising:
a processor; and
memory storing instructions that when executed by the processor cause the transmitter to:
negotiate a wireless connection between the transmitter and a receiver to wirelessly couple the transmitter and the receiver, wherein the transmitter comprises a computing device;
establish a wireless display service connection between the transmitter and the receiver;
register an application via an operating system of the transmitter, the application stored in the memory of the transmitter;
enable the application via the instructions comprising a transfer stack for the wireless display service connection; and
operate the application between the transmitter and the receiver via the wireless display service connection.

10. The transmitter of claim 9, wherein to enable the application via the transfer stack comprises enabling the wireless connection via a real time streaming protocol (RTSP) of the transfer stack for the wireless display connection.

11. The transmitter of claim 9, wherein the operating system of the transmitter comprises a framework application program interface (API) for registering the application.

12. The transmitter of claim 9, wherein the wireless connection comprises a Wi-Fi Direct® connection.

13. The transmitter of claim 9, wherein the wireless display service connection comprises a Miracast™ connection.

14. The transmitter of claim 9, wherein to enable the application via the transmitter transfer stack comprises to enable the application without reliance on the operating system.

15. The transmitter of claim 9, wherein the instructions comprise an update to the operating system for the operating system to register applications.

16. The transmitter of claim 9, wherein the instructions when executed by the processor cause the transmitter to wirelessly stream video or audio, or both, from the transmitter to the receiver over the wireless connection and the wireless display service connection.

17. A tangible, non-transitory, computer-readable medium comprising instructions that, when executed by a processor of a computing device, direct the computing device to:
negotiate a wireless connection between a transmitter and a receiver to wirelessly couple the transmitter and the receiver, wherein the transmitter comprises the computing device;
establish a wireless display service connection between the transmitter and the receiver;
register an application via an operating system of the transmitter, the application stored in memory of the transmitter; and
enable the application via the instructions comprising a transfer stack for the wireless display service connection.

18. The non-transitory, computer-readable medium of claim 17, wherein the instructions are executable by a processor to operate the application between the transmitter and the receiver via the wireless display service connection.

19. The non-transitory, computer-readable medium of claim 17, wherein to enable the application via the transfer stack comprises enabling the wireless connection via a real time streaming protocol (RTSP) of the wireless display connection.

20. The non-transitory, computer-readable medium of claim 17, wherein the operating system of the transmitter comprises a framework application program interface (API) for registering the application.

21. The non-transitory, computer-readable medium of claim 17, wherein the wireless connection comprises a Wi-Fi Direct° connection.

22. The non-transitory, computer-readable medium of claim 17, wherein the wireless display service connection comprises a Miracast™ connection.

23. The non-transitory, computer-readable medium of claim 17, wherein to enable the application via the transmitter transfer stack comprises to enable the application without reliance on the operating system.

24. The non-transitory, computer-readable medium of claim 17, wherein the instructions comprise an update to the operating system for the operating system to register the application.

25. The non-transitory, computer-readable medium of claim 17, wherein the transmitter to wirelessly stream video or audio, or both, from the transmitter to the receiver over the wireless connection and the wireless display service connection.
